(19) United States
(12) Patent Application Publication
(10) Pub. No.: US 2012/0158433 A1
(43) Pub. Date: Jun. 21, 2012

(54) MEDICAL PROCEDURE OUTCOME SYSTEM

(76) Inventors: Reinhold Schmieding, Naples, FL (US); Bryan T. Hanypsiak, Naples, FL (US); Ashley Willobee, Gulf Breeze, FL (US); James H. Lubowitz, Taos, NM (US); Daniel C. Beard, Estero, FL (US); Uwe Kronewiter, Estero, FL (US); Amy S. Roller, Naples, FL (US)

(21) Appl. No.: 13/329,872

(22) Filed: Dec. 19, 2011

Related U.S. Application Data
(60) Provisional application No. 61/425,097, filed on Dec. 20, 2010.

(51) Int. Cl. G06Q 50/24

(52) U.S. Cl. 705/3

(57) ABSTRACT

An internet-based patient health outcome data collection system, and a system for accessing information from the collected database. The system includes a web-based patient and doctor interface that allows both a patient and doctor to separately input data into the data collection database. The web-based patient interface allows a patient to input data such as responses to questions regarding levels of pain, function, satisfaction, quality of life, activities of daily living, unexpected results, and questions, pre- and post-procedure. The doctor interface also includes an analysis tool that allows the doctor to analyze the data from a specific patient, a group of patients, or all the patients, with specific characteristics as chosen by the doctor. The doctor interface also allows the doctor to compare an individual patient against a group of the doctor's patients, all patients in the study that meet criteria chosen by the doctor, or global data.

This application claims the benefit of U.S. Provisional Application No. 61/425,097, filed on Dec. 20, 2011.

### FIELD OF THE INVENTION

The present invention is directed to a health outcome data collection system and, more particularly, to an internet-based medical procedure outcome system that collects data from patients and doctors to create an interactive health outcome data collection system and allow analysis of the collected data.

### BACKGROUND OF THE INVENTION

A database for measuring and recording patient treatment results is effective for answering clinical questions with regard to outcomes, costs, and cost-effectiveness of medical procedures. Information on large numbers of patients, treated by large numbers of providers, and the outcomes of the medical treatments, are collected and input into the database.

The information in a medical outcome database may include baseline characteristics, procedure interventions and costs, and subsequent outcomes of subjects, and allows subsequent retrospective and prospective review and analysis of specific included cohorts of subjects as well as comparative-effectiveness research of different cohorts. The collected data provides a measurement for the value of orthopedic sports medicine, arthroscopy procedures, arthroplasty and other medical procedures. The collected data also allows a user to compare products and procedures, not just on the basis of cost or reimbursement, but on outcomes and objective findings as well. Utilization of a practice based orthopedic procedure registry across a broad provider network may also enable the efficient collection of scientific evidence adequate to permit analysis of outcomes, costs, and cost-effectiveness associated with medical interventions and approved orthopedic devices. As a result, a health outcome data collection system allows determination of the comparative effectiveness of different procedures and, ultimately, a determination of the best method for treating patients.

Accordingly, it would be desirable to provide a health outcome data collection system that is efficient, easy to use and provides compilation of data to provide valuable information regarding the efficiency and cost-effectiveness of medical procedures.

### SUMMARY OF THE INVENTION

The present invention provides an internet-based patient health outcome data collection system, and a system for accessing information from the collected database. The system includes a web-based patient and doctor interface that allows both a patient and doctor to separately input data into the data collection database. The web-based patient interface allows a patient to input data such as responses to questions regarding levels of pain, function, satisfaction, quality of life, activities of daily living, unexpected results, and questions, pre- and post-procedure. The doctor interface also includes an analysis tool that allows the doctor to analyze the data from a specific patient, a group of patients, or all the patients, with specific characteristics as chosen by the doctor. The doctor interface also allows the doctor to compare an individual patient against a group of the doctor's patients, all patients in the study that meet criteria chosen by the doctor, or global data. In this manner, the invention provides a comprehensive way of tracking a patient from beginning to end.

The present invention also provides a method of collecting patient data for the health outcome data collection system. The method comprises the following steps: a doctor inputs general patient information; next, the system generates a questionnaire and notifies the patient about the questionnaire; the patient then accesses the system through a secure web-link included in the email from the system and responds to the questionnaire; next, the doctor performs the procedure (or any type of health treatment) and inputs information about the procedure, the diagnosis, and recovery into the system; the system generates another questionnaire and notifies the patient about the questionnaire; and the patient then accesses the system through a secure web-link in the email sent from the system and responds to the questionnaire. This feedback can be used to alert the doctor to complications. Multiple questionnaires may be generated and responded to at varying intervals, before and after the procedure. The system automatically scores each questionnaire individually and adds their scores into the database. The doctor reviews and analyzes the patient's response and compares the response to averages from other patients in the database.

Global de-identified data is automatically compiled for third party data analysis and use by all doctors, worldwide, for comparison purposes.

These and other features and advantages of the invention will be more apparent from the following detailed description that is provided in connection with the accompanying drawings and illustrated exemplary embodiments of the invention.

### BRIEF DESCRIPTION OF THE DRAWINGS

FIG. 1 illustrates a procedure outcome system with a database;

FIG. 2 illustrates an exemplary method of using the system of FIG. 1 to collect patient data;

FIG. 3 illustrates an exemplary patient details interface of the system of FIG. 1 used by a doctor to input data;

FIG. 4 illustrates an exemplary current patients interface of the system of FIG. 1 used by a doctor to monitor patients;

FIG. 5 illustrates an exemplary patient analysis interface used by a doctor to analyze data;

FIG. 6 illustrates an exemplary patient input interface used by a patient to input data; and

FIG. 7 illustrates another exemplary patient input interface used by a patient to input data.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art.

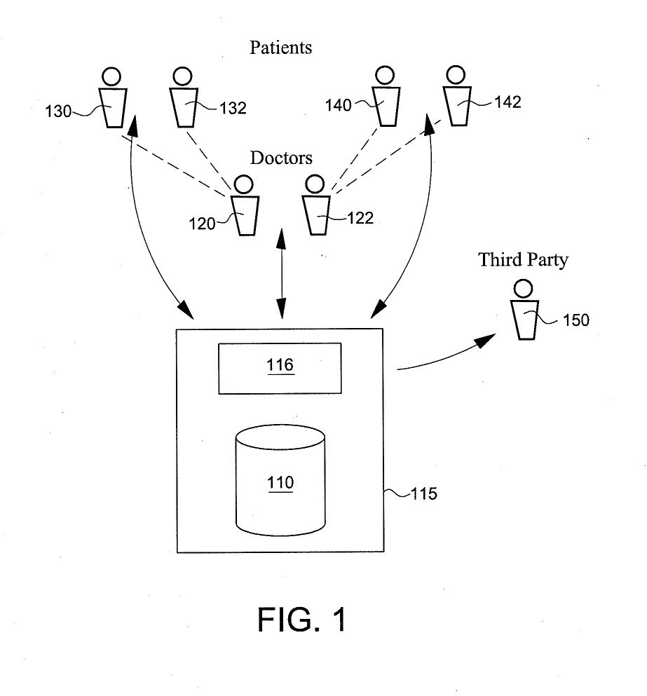

FIG. 1 illustrates a procedure outcome system 115 that includes a database 110. The procedure outcome system 115 allows for data collection and analysis of the data. The system 115 employs a web-portal 116 to collect data from doctors 120, 122. Designees for each doctor 120, 122 may also access the system 115 and input and view information on behalf of the doctors 120, 122. If one person is designee for more that one doctor, that person will be able to access surgeons' data from one access point. The system 115 also collects data from patients 130, 132 of doctor 120 and patients 140, 142 of doctor 122. System 115 is not limited to collecting data from only a certain number of doctors and/or a certain number of patients of each doctor, but is robust and may handle data input from numerous doctors and their patients or other patients.

Using the web-portal 116 of system 115, the doctors 120, 122 view the data collected from their respective patients 130, 132 and 140, 142. The doctors 120, 122 may also compare data from their respective patients 130, 132 and 140, 142 with de-identified data averages collected from all the patients 130, 132, 140, 142. Further if a doctor chooses to show the patient, each patient 130, 132, 140, 142 may view his/her data and also data averages collected from all the patients 130, 132, 140, 142. Additionally, third parties 150 may also enter data and view combined datasets collected from all the patients 130, 132, 140, 142.

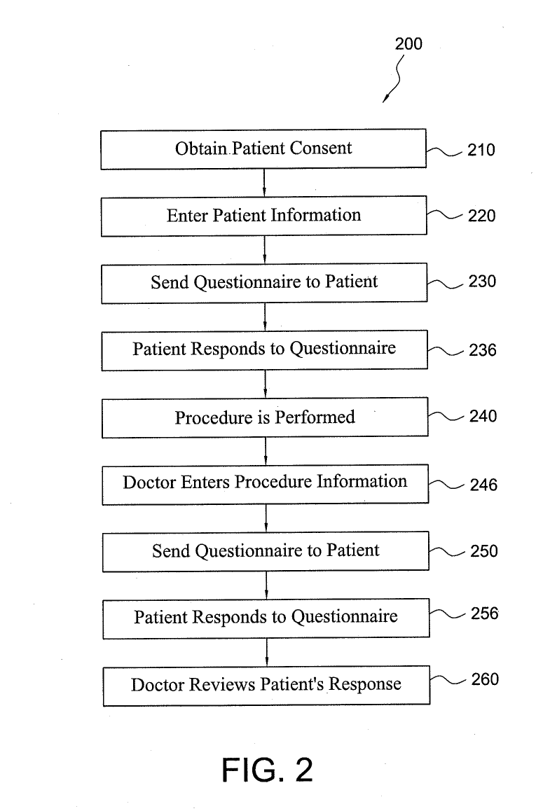

A data collection method 200 for collecting data from the patient 130 and the patient's doctor 120 using the system 115 is described with regard to FIG. 2. Step 210 of data collection method 200 involves obtaining an authorization to participate from patient 130 before a patient is included in the system (and before the procedure is performed). During step 220, the doctor 120 accesses the system 115 through the on-line interface or web portal 116 and enters the information of the patient 130 into the database 110. During step 230, the system 115 sends a notification to the patient 130 that the system 115 has generated a questionnaire for the patient 130. The system 115 notifies the patient 130 through email. The email includes a URL (uniform resource locator) that will direct the patient 130 to the web-portal 116. Additionally, the patient 130 may be notified by telephone, mail, text message or other means of communication. During step 236, the patient 130 accesses the web-portal 116 or wireless data collection tool (IPAD) of system 115 and responds to the system generated questionnaire. The system automatically scores the given responses to each questionnaire and saves each individual score in the database.

The procedure is performed on the patient 130 by the doctor 120 during step 240. During step 245, the doctor 120 accesses the system's web-portal 116 and enters related post-procedure information into the database 110. The system 115 then generates an additional questionnaire and sends a notification to the patient 130 that a questionnaire has been generated during step 250. The notification sent during step 250 may be similar to the notification sent to the patient 130 during step 230. The patient 130 then accesses the web-portal 116 of the system 115 during step 256 and responds to the questionnaire. Steps 250 and 256 may be repeated numerous times, using a different combination of questionnaires at each time. For example, the system 115 may generate questionnaires for the patient 130 and repeat steps 250 and 256 at the following post-procedure times: 3 days, 7 days, 2 weeks, 4 weeks, 6 weeks, 3 months, 6 months and 1 and 2 years. As the patient 130 responds to the questionnaires during step 256, the doctor 120 tracks and monitors the patient's responses to the questionnaires during step 260. The system 115 may also send a notification to the doctor 120 depending on the responses given by the patient 130 in step 256. For example, if the patient's 130 response indicates that the patient 130 is experiencing a health problem related to the procedure, the system 115 may notify the doctor 120 of the problem.

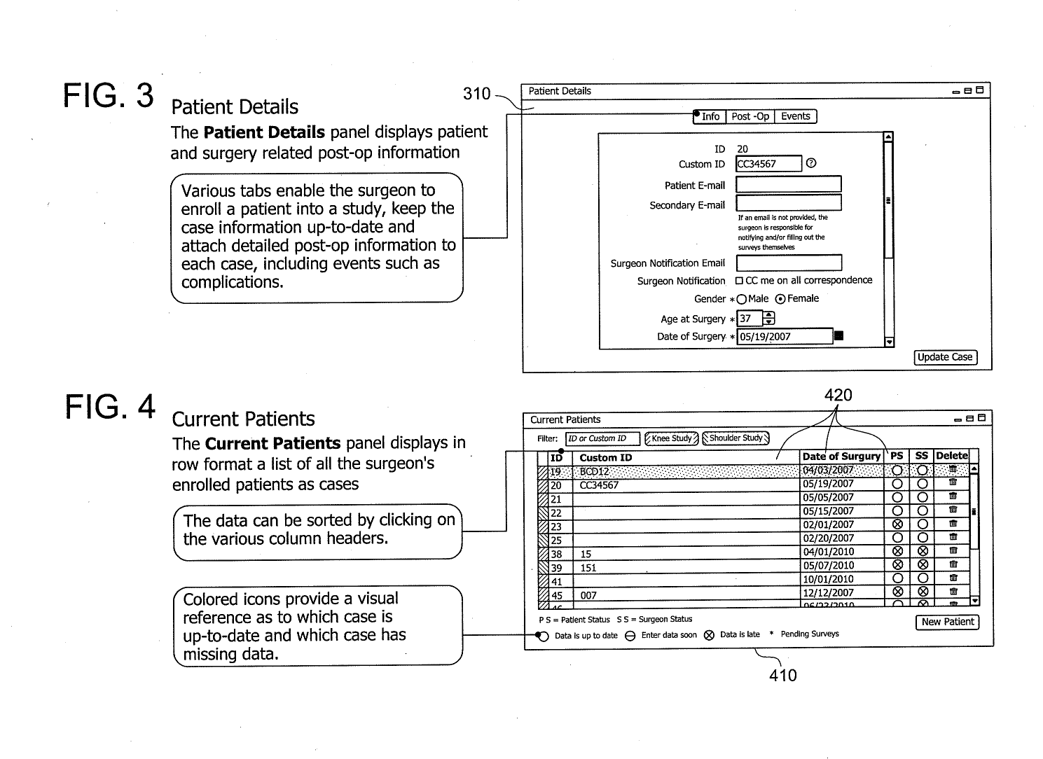

FIGS. 3-5 illustrate various aspects of the portion of the web-portal 116 provided to the doctor 120. FIG. 3 illustrates a patient details interface 310 used by the doctor 120 to input data concerning the patient 130. For example, before the procedure on the patient 130, the doctor 120 accesses the system 115 through the web-portal 116 using a unique login and password and enters the patient's 130 Custom ID (or medical record number) which uniquely identifies the patient, the date that the patient authorization was signed, the projected date of procedure, demographic data, general medical history, diagnosis, and the doctor's 120 and patient's 130 e-mail addresses. Additional information fields include gender, age at procedure, date of procedure, doctor, facility cost, procedure time, workers comp case, medical history, and site of the injury.

After the procedure, the doctor 120 enters information about the exact diagnosis and concomitant injuries experienced by the patient 130. The doctor also enters information about the procedure performed, including the type of procedure, cost data, medicine use, and any graft and implant use. For example, if the patient 130 had complications with his/her knee, the system 115 may require the doctor 120 to input the exact diagnosis and concomitant injuries associated with the complications, the procedure that was performed, the type of graft used if any, and the type of implant used if any. For example, the system 115 may prompt the doctor 120 to select all the following types of injuries that could apply and then provide the doctor 120 with the following list: ACL Tear, PCL Tear, MCL Tear, LCL Tear, PLC Tear, MMT, LMT, Loose Body (>1 cm), Synovitis, Patellar Dislocation/Patello-femoral, Knee Dislocation, Previous HTO, Articular Cartilage Injury (Outerbridge Grade). To ensure uniformity in the database 110, the system 115 only allows the doctor 120 to check options that apply, and limits written input—written input may be allowed in certain fields, but with the understanding by the doctor that data cannot be filtered in the analysis section.

Similar lists could be provided for the type of procedure or treatment performed and/or the type of graft or implant used. For example, the system 115 may prompt the doctor 120 to select from the following types of procedures that were performed: ACL reconstruction, PCL reconstruction or repair, MCL reconstruction or repair, LCL reconstruction or repair, meniscectomy repair, cartilage repair, osteotomy, etc.

The doctor 120 also enters any other non-surgical treatment, such as injections/applications, or complications during the period for which the patient 130 is responding to questionnaires. The system may prompt the surgeon to enter post-operative physical examination measurements depending on the procedures done on the patient.

FIG. 4 illustrates a current patients interface 410 used by the doctor 120 to monitor his or her patients 130, 132. The current patients interface 410 allows a user to filter patient cases. The current patients interface 410 also provides a visual reference as to which patient information is up-to-date and which patient has missing data.

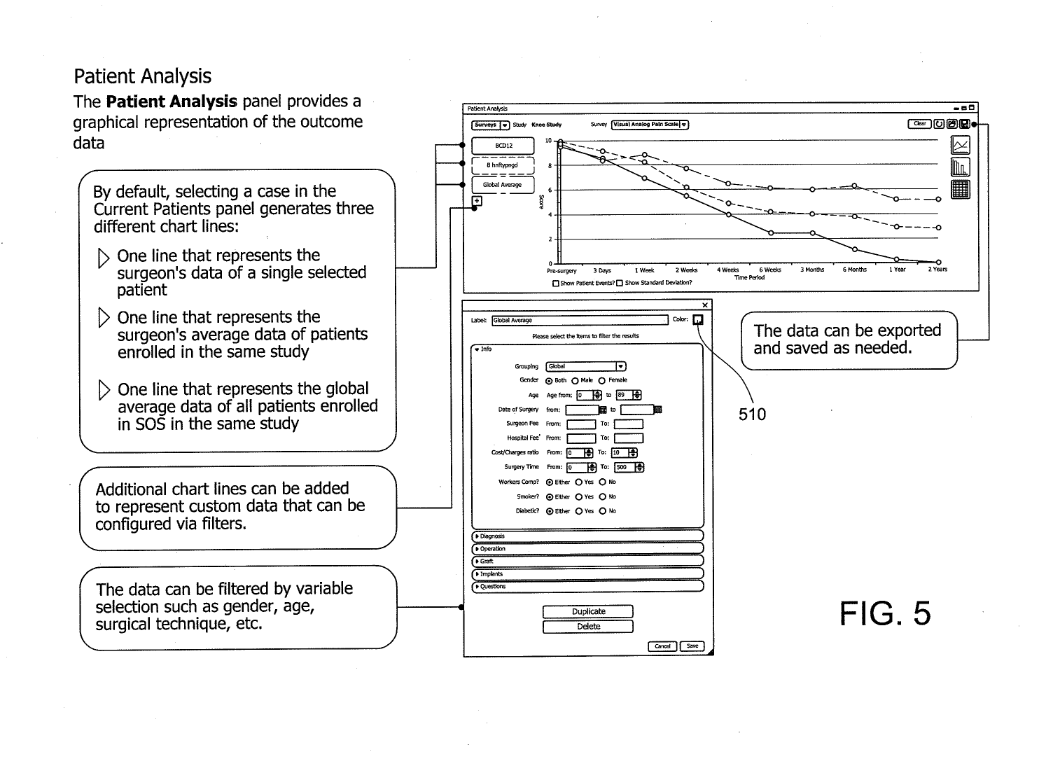

FIG. 5 illustrates a patient analysis interface 510 used by the doctor 120 to track and analyze the data provided by the doctors 120, 122 and patients 130, 132, 140, 142. The doctor 120 may view a graph representing the data from a single patient 130, all the doctor's 120 patients 130, 132, or all the patients 130, 132, 140, 142 in the system 115. Additional customized graphs or reports may also be created based on selected variables such as gender, age, surgical technique, surgical device, other treatments, medicine used, etc. This allows the doctor 120 or a third party 150 to compare results between surgical devices, medicine, and/or techniques, and to view outcomes (scores) of patients. Further, the data from the database 110 may be analyzed to determine the effectiveness and cost-effectiveness of procedures and implants. The system 115 may also be used to educate the patients 130, 132, 140, 142 on average recovery times and the average length and intensity of pain following a procedure. Additionally, datasets from one site or multiple sites can be combined for surgeon groups at one facility or multi-site clinical studies.

Other features and attributes of the system are as follows:
The doctor may generate pdf forms of selected criteria from patient data. This document can be printed or saved in pdf format.
The doctor may attach certain de-identified images to patient cases.
The doctor may allow his or her EMR company to draw information from or add information to the system.
The doctor may select certain patient information to export.
The doctor may import previously collected patient data into the system.
The doctor may choose to customize certain fields of the database including but not limited to time points of survey collection, questionnaires, objective measurements pre and post-op. Customization can be done alone, at a site, and at the surgeon or patient level.
The doctor may be able to select language translations for individual patients as well as to surgeon portal.
The doctor may be able to assign various privilege levels to their designers including, but not limited to, access to billing/payment screen, access to patient analysis, access to data entry, ability to customize/modify surgeon parameters.
The doctor may be able to add a note section to an individual patient case.

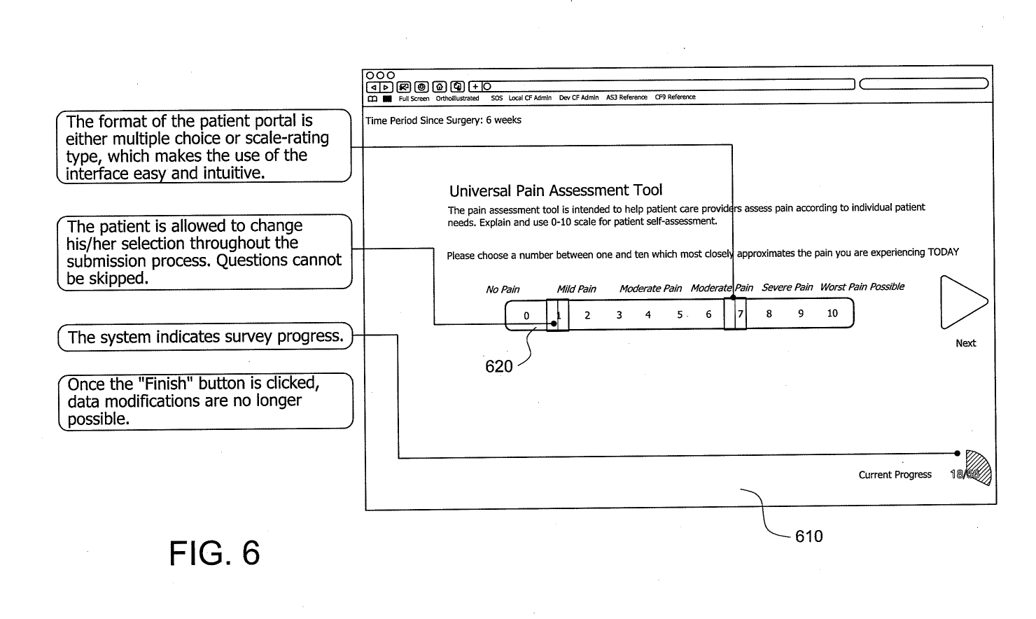

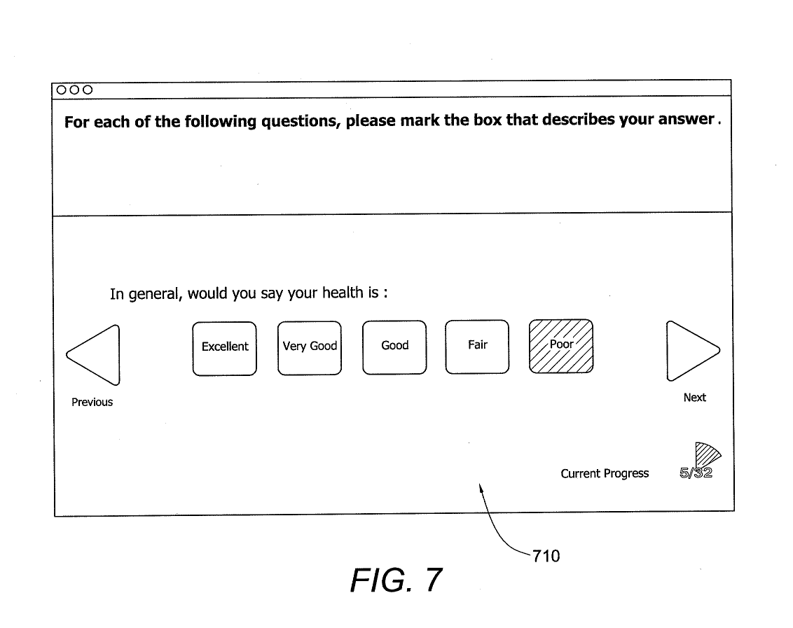

FIG. 6 illustrates a patient input interface 610 used by the patient 130 to input data (i.e., responses to questions) into the database 110. Patient input interface 610 allows the patient 130 to respond to questions using a VAS (Visual Analog Scale) 620 or other forms of response such as the response dialog 710 shown in FIG. 7. The questionnaires generated by the system 115 address questions regarding health related quality of life, pain, and function. For example, if patient 130 is scheduled for knee arthroscopy treatment, the patient 130 may be requested to complete the SF-12, KOOS (Knee injury and Osteoarthritis Outcome Score), VAS (Visual Analog Scale) and/or Marx Activity Score (pre-op, and 1 and 2 years post-op only). Similarly, if the patient 130 is scheduled for shoulder arthroscopy treatment, the patient 130 may be requested to complete the SF-12, Simple Shoulder Test (SST), American Shoulder and/or Elbow Surgeon's Subjective Shoulder Scale (ASES).

Additionally, before the procedure, the patient 130 may also be asked to answer questions related to his or her post-procedure expectations (pain reduction, improvement in motion and strength, normal function for daily living and/or normal function for sports). Post operation, at multiple times, such as at 3 days, 7 days, and 2 and 4 weeks post-procedure, the patient 130 may be requested to rate their level of pain using the VAS and answer if they are taking pain and/or sleeping medication due to their procedure. At 6 weeks, 3 months, 6 months, and 1 and 2 years post-procedure, the patient 130 may complete the same surveys for health related quality of life, pain and function as he/she did pre-procedure. Additionally, at 1 year post-procedure, the patient 130 may be asked if the procedure met his/her expectations. At each post-procedure time point, the patient 130 may be requested to check a yes/no response box if he or she has had any unexpected events. If the “Yes” response box is checked for unexpected events, an email may be sent to the doctor 120 to alert the doctor 120. If the patient 130 fails to complete the surveys and provide the data in the specified time, an additional email reminder may be sent to the patient 130 to request completion.

All data transfer and data communication between the system 115 and the doctor 120 and the patient 130 takes place online over a secure, encrypted channel (SSL). Data can be entered by the patient 130 or the doctor 120 if the patient 130 does not have access to a computer, using the web-portal 116 or “IPAD.” To access the portal, the patient 130 clicks on a link in an e-mail that he or she receives from the system 115, which directs the patient 130 to the secure portal landing page. The doctor 120 can also access the same link from within the system 115. The link contains a query string that uniquely identifies the patient as well as the data point for which the data submission is being made. The link generated is completely random and is not determined based on any of the patient's 130 identifiable information.

Access to the system 115 by the doctor 120 and the patient 130 is carefully controlled by the system 115, and data within the database 110 is kept as confidential as possible. The doctor 120 has a unique login and password in order to access, view and input data into the system 115. The doctor 120 is only able to view his or her patients' data as well as global average values of the de-identified data in the database 110. The doctor 120 will not be able to view the doctor's 122 data other than in the form of global averages unless a data sharing agreement is executed by all parties involved.

Although the present invention has been described in connection with preferred embodiments, many modifications and variations will become apparent to those skilled in the art. While the preferred embodiments have been described and illustrated above, it should be understood that these are exemplary only and are not to be considered as limiting.

What is claimed is:

1. An internet-based patient health outcome data collection system, comprising:
a web-based patient interface for entering data by a patient into the data collection database;
a web-based doctor interface for entering data by a doctor into the data collection database; and
an analysis tool for analyzing the data input into the data collection database from a specific patient or from a plurality of patients.

2. The data collection system of claim 1, wherein the analysis tool allows the doctor to compare data from an individual patient against a group of the doctor's patients, from all patients in the database that meet a criteria chosen by the doctor, or from all patients in the system.

3. The data collection system of claim 1, wherein the data entered by the doctor includes information about the patient and information about a procedure or treatment.

4. The data collection system of claim 1, wherein the data entered by the patient includes information about expectations of the patient, or the effects of a procedure or treatment performed on the patient.

5. An internet-based method of patient health outcome data collection, comprising the steps of:
entering data, by a doctor, regarding a patient, via the Intenet, into a data collection database and regarding a procedure or treatment;
sending a questionnaire, via the Internet, to the patient, regarding the patient's expectations or effects of the procedure or treatment; and
entering data, by the patient, in response to the questionnaire, and sending that data to the data collection database over the Internet.

6. The method of data collection recited in claim 5, further comprising the step of compiling and analyzing the data input by the patient, or by a plurality of patients.

7. The method of data collection recited in claim 5, wherein multiple questionnaires are sent to the patient at various time intervals.

8. The method of data collection recited in claim 5, wherein the questionnaire is sent to the patient by email.

9. The method of data collection recited in claim 5, wherein the doctor enters information about the patient into the data collection database both before and after the procedure or treatment.

10. The method of data collection recited in claim 5, wherein the data regarding the procedure or treatment is entered by the doctor from a list.

11. The method of data collection recited in claim 6, wherein the doctor uses a patient analysis interface to generate a graph to analyze the data.

12. The method of data collection recited in claim 6, further comprising the step of determining the effectiveness or cost effectiveness of a treatment or procedure using the analyzed data.

13. The method of data collection recited in claim 5, further comprising the step of generating pdf forms of selected criteria from the data entered by the patient.

14. The method of data collection recited in claim 5, further comprising the step of attaching de-identified images to patient cases.

15. The method of data collection recited in claim 5, further comprising the step of importing previously collected patient data.
